(19) United States
(12) Patent Application Publication
(10) Pub. No.: US 2021/0277288 A1
(43) Pub. Date: Sep. 9, 2021

(54) PRESSURE-SENSITIVE ADHESIVE TAPE

(71) Applicant: NITTO DENKO CORPORATION, Osaka (JP)

(72) Inventors: Mariko TESHIBA, Ibaraki-shi (JP); Kouji MIZUNO, Ibaraki-shi (JP)

(21) Appl. No.: 17/189,617

(22) Filed: Mar. 2, 2021

(30) Foreign Application Priority Data
Mar. 6, 2020 (JP) 2020-038457

(51) Int. Cl. C09J 7/38; C08F 2/50; C08F 220/06; C08F 220/18; C08F 220/20; C08F 220/36; C08F 222/10; C08F 226/06

(52) U.S. Cl. CPC C09J 7/385; C09J 2467/001; C08F 220/06; C08F 220/1802; C08F 220/1804; C08F 220/1808; C08F 220/20; C08F 220/36; C08F 222/103; C08F 226/06; C09J 2203/326; C09J 2301/122; C09J 2301/208; C09J 2301/302; C09J 2433/00; C08F 2/50

(57) ABSTRACT

Provided is a pressure-sensitive adhesive tape having excellent pressure-sensitive adhesive strength to an adherend before ultraviolet (UV) irradiation and excellent peelability after UV irradiation. The pressure-sensitive adhesive tape includes: a pressure-sensitive adhesive layer containing a UV-curable pressure-sensitive adhesive and a photopolymerization initiator; an intermediate layer containing the photopolymerization initiator and being free from a UV-curable component; and a base material. When the intermediate layer contains the photopolymerization initiator, excellent peelability can be exhibited after UV irradiation.

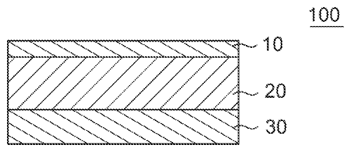

This application claims priority under 35 U.S.C. Section 119 to Japanese Patent Application No. 2020-038457 filed on Mar. 6, 2020, which is herein incorporated by reference.

### BACKGROUND OF THE INVENTION

### Field of the Invention

The present invention relates to a pressure-sensitive adhesive tape.

### Description of the Related Art

A semiconductor wafer is used for various usages, such as a personal computer, a smartphone, and an automobile. In the processing step of the semiconductor wafer, a pressure-sensitive adhesive tape is used for protecting a surface thereof at the time of processing. In recent years, miniaturization and high functionalization of a large-scale integration (LSI) have been proceeding, and a surface structure of the wafer has become complicated. For example, a wafer surface may be formed using a plurality of materials. In addition, a three-dimensional structure of the wafer surface has also become complicated because of a solder bump or the like. Accordingly, a difference in pressure-sensitive adhesive strength may occur to generate an adhesive residue because of the material and the structure of the wafer surface. In recent years, along with downsizing and thinning of products, thinning of the semiconductor wafer has been advanced. In the wafer processed into a thin shape, when the pressure-sensitive adhesive strength of the pressure-sensitive adhesive tape is too high, breakage may occur in the wafer itself at the time of peeling of the pressure-sensitive adhesive tape. In order to prevent an adhesive residue on an adherend and the breakage of the wafer at the time of peeling, a pressure-sensitive adhesive tape using an ultraviolet (UV)-curable pressure-sensitive adhesive has been proposed (Japanese Patent Application Laid-open No. H6-49420 and Japanese Patent Application Laid-open No. S62-153376). However, even when the UV-curable pressure-sensitive adhesive is used, there may occur a problem in that desired peelability is not exhibited to cause the adhesive residue on the adherend and the breakage of the wafer.

### SUMMARY OF THE INVENTION

The present invention has been made to solve the above-mentioned problems of the related art, and is directed to provide a pressure-sensitive adhesive tape having excellent pressure-sensitive adhesive strength to an adherend before ultraviolet (UV) irradiation and excellent peelability after UV irradiation.

According to at least one embodiment of the present invention, there is provided a pressure-sensitive adhesive tape, including: a pressure-sensitive adhesive layer containing a UV-curable pressure-sensitive adhesive and a photopolymerization initiator; an intermediate layer containing the photopolymerization initiator and being free from a UV-curable component; and a base material.

In at least one embodiment of the present invention, a content of the photopolymerization initiator in a composition for forming the intermediate layer is from 0.1 part by weight to 10 parts by weight.

In at least one embodiment of the present invention, the pressure-sensitive adhesive layer and the intermediate layer each contain the photopolymerization initiator in an equal amount.

In at least one embodiment of the present invention, the base material has an antistatic function.

In at least one embodiment of the present invention, the pressure-sensitive adhesive layer after UV irradiation has a ratio between a silicon pressure-sensitive adhesive strength and a polyimide pressure-sensitive adhesive strength of 1.0 or less.

In at least one embodiment of the present invention, the pressure-sensitive adhesive layer has a thickness of from 1 μm to 10 μm.

In at least one embodiment of the present invention, the base material has a thickness of from 10 μm to 200 μm.

In at least one embodiment of the present invention, the pressure-sensitive adhesive tape is used in a semiconductor wafer processing step.

In at least one embodiment of the present invention, the pressure-sensitive adhesive tape is used as a backgrind tape.

In at least one embodiment of the present invention, the pressure-sensitive adhesive tape is used by being bonded to an adherend having unevenness.

### BRIEF DESCRIPTION OF THE DRAWING

The FIGURE is a schematic sectional view of a pressure-sensitive adhesive tape according to at least one embodiment of the present invention.

### DESCRIPTION OF THE EMBODIMENTS

### A. Summary of Pressure-Sensitive Adhesive Tape

The FIGURE is a schematic sectional view of a pressure-sensitive adhesive tape according to at least one embodiment of the present invention. In the illustrated example, a pressure-sensitive adhesive tape 100 includes a base material 30, an intermediate layer 20, and a pressure-sensitive adhesive layer 10. The pressure-sensitive adhesive layer 10 contains an ultraviolet (UV)-curable pressure-sensitive adhesive and a photopolymerization initiator. The intermediate layer 20 contains the photopolymerization initiator and is free from a UV-curable component. Accordingly, the intermediate layer is not cured even by UV irradiation, and flexibility can be maintained. In addition, when the intermediate layer contains the photopolymerization initiator, the photopolymerization initiator in the pressure-sensitive adhesive layer does not transfer to the intermediate layer, and reduction of the content of the photopolymerization initiator in the pressure-sensitive adhesive layer caused by the photopolymerization initiator transferring from the pressure-sensitive adhesive layer to the intermediate layer over time can be prevented. Accordingly, the pressure-sensitive adhesive layer is appropriately cured by UV irradiation, and a desired light peelability can be exhibited. As a result, an adhesive residue on an adherend and the breakage of a thinned wafer can be prevented.

In at least one embodiment of the present invention, the pressure-sensitive adhesive layer and the intermediate layer each contain the photopolymerization initiator in an equal amount. When the pressure-sensitive adhesive layer and the intermediate layer each contain the photopolymerization initiator in an equal amount, the content of the photopolymerization initiator in the pressure-sensitive adhesive layer can be further maintained with time. As used herein, the “equal amount” means that the content (concentration) of the photopolymerization initiator in the pressure-sensitive adhesive layer and the content (concentration) of the photopolymerization initiator in the intermediate layer are equal to each other. Specifically, the content of the photopolymerization initiator in a composition for forming the pressure-sensitive adhesive layer and the content of the photopolymerization initiator in a composition for forming the intermediate layer are equal to each other.

The thickness of the pressure-sensitive adhesive tape may be set to any appropriate range, and is preferably from 10 μm to 1,000 μm, more preferably from 50 μm to 300 μm, still more preferably from 100 μm to 300 μm.

### B. Base Material

The base material may be formed of any appropriate resin. Specific examples of the resin for forming the base material include polyester-based resins, such as polyethylene terephthalate (PET), polyethylene naphthalate (PEN), polybutylene terephthalate (PBT), and polybutylene naphthalate (PBN), polyolefin-based resins, such as an ethylene-vinyl acetate copolymer, an ethylene-methyl methacrylate copolymer, polyethylene, polypropylene, and an ethylene-propylene copolymer, polyvinyl alcohol, polyvinylidene chloride, polyvinyl chloride, a vinyl chloride-vinyl acetate copolymer, polyvinyl acetate, polyamide, polyimide, celluloses, a fluorine-based resin, polyether, polystyrene-based resins, such as polystyrene, polycarbonate, and polyether sulfone. Of those, polyethylene terephthalate, polyethylene naphthalate, polybutylene terephthalate, and polybutylene naphthalate are preferably used. When those resins are used, an occurrence of warpage can be further prevented.

The base material may further include another component to the extent that the effects of the present invention are not inhibited. Examples of the other component include an antioxidant, a UV absorber, a light stabilizer, and a heat stabilizer. With regard to the kind and usage amount of the other component, the other component may be used in any appropriate amount in accordance with purposes.

In at least one embodiment of the present invention, the base material has an antistatic function. When the base material has an antistatic function, an occurrence of static electricity at the time of peeling of the tape is suppressed, and breakdown of a circuit by static electricity and adhesion of foreign matter can be prevented. The base material may have an antistatic function by being formed of a resin containing an antistatic agent, or may have an antistatic function by applying a composition containing an antistatic component, such as a conductive polymer, an organic or inorganic conductive substance, or an antistatic agent, to any appropriate film to form an antistatic layer. When the base material includes the antistatic layer, the intermediate layer is preferably laminated onto a surface on which the antistatic layer is formed.

When the base material has an antistatic function, the base material has a surface resistance value of, for example, from 1.0×10²Ω/□ to 1.0×10¹³Ω/□, preferably from 1.0×10⁶Ω/□ to 1.0×10¹²Ω/□, more preferably from 1.0×10⁷Ω/□ to 1.0×10¹¹Ω/□. When the surface resistance value falls within the above-mentioned ranges, the occurrence of static electricity at the time of peeling of the tape is suppressed, and breakdown of a circuit by static electricity and adhesion of foreign matter can be prevented. When the base material having an antistatic function is used as the base material, the pressure-sensitive adhesive tape to be obtained may have a surface resistance value of, for example, from 1.0×10⁶Ω/□ to 1.0×10¹²Ω/□.

The thickness of the base material may be set to any appropriate value. The thickness of the base material is preferably from 10 μm to 200 μm, more preferably from 20 μm to 150 μm.

The elastic modulus of the base material may be set to any appropriate value. The elastic modulus of the base material is preferably from 50 MPa to 6,000 MPa, more preferably from 70 MPa to 5,000 MPa. When the elastic modulus falls within the above-mentioned ranges, the pressure-sensitive adhesive tape that can appropriately follow the unevenness of an adherend surface can be obtained.

### C. Pressure-Sensitive Adhesive Layer

The pressure-sensitive adhesive layer is formed by using any appropriate composition for forming a pressure-sensitive adhesive layer. The composition for forming a pressure-sensitive adhesive layer (the resulting pressure-sensitive adhesive layer) contains a UV-curable pressure-sensitive adhesive and a photopolymerization initiator. When the UV-curable pressure-sensitive adhesive is incorporated, the pressure-sensitive adhesive tape having excellent pressure-sensitive adhesive strength to an adherend before UV irradiation and excellent peelability after UV irradiation can be provided.

### C-1. UV-Curable Pressure-Sensitive Adhesive

Any appropriate pressure-sensitive adhesive may be used as the UV-curable pressure-sensitive adhesive. For example, a pressure-sensitive adhesive obtained by adding a UV-curable monomer and/or oligomer to any appropriate pressure-sensitive adhesive, such as an acrylic pressure-sensitive adhesive, a rubber-based pressure-sensitive adhesive, a silicone-based pressure-sensitive adhesive, or a polyvinyl ether-based pressure-sensitive adhesive, may be adopted, or a pressure-sensitive adhesive using a polymer having a polymerizable carbon-carbon double bond in a side chain or at a terminal thereof as a base polymer may be adopted. Of those, a pressure-sensitive adhesive using a polymer having a polymerizable carbon-carbon double bond in a side chain or at a terminal thereof as a base polymer is preferably used.

When the pressure-sensitive adhesive using a polymer having a polymerizable carbon-carbon double bond in a side chain or at a terminal thereof is used, a polymer having a polymerizable carbon-carbon double bond in a side chain or at a terminal thereof and having a pressure-sensitive adhesive property is used as the base polymer. Examples of such polymer include polymers each obtained by introducing a polymerizable carbon-carbon double bond into a resin, such as a (meth)acrylic resin, a vinyl alkyl ether-based resin, a silicone-based resin, a polyester-based resin, a polyamide-based resin, a urethane-based resin, or a styrene-diene block copolymer. Of those, a (meth)acrylic polymer obtained by introducing a polymerizable carbon-carbon double bond into a (meth)acrylic resin is preferably used. When the (meth)acrylic polymer is used, a pressure-sensitive adhesive tape in which the storage elastic modulus and the tensile elastic modulus of the pressure-sensitive adhesive layer are easily adjusted, and which is excellent in balance between pressure-sensitive adhesive strength and peelability can be obtained. Further, contamination of an adherend by a component derived from the pressure-sensitive adhesive can be reduced. The “(meth)acrylic” refers to acrylic and/or methacrylic.

Any appropriate (meth)acrylic resin may be used as the (meth)acrylic resin. An example of the (meth)acrylic resin is a polymer obtained by polymerizing a monomer composition containing one kind or two or more kinds of esters of acrylic acid or methacrylic acid each having a linear or branched alkyl group.

The linear or branched alkyl group is preferably an alkyl group having 30 or less carbon atoms, more preferably an alkyl group having 1 to 20 carbon atoms, still more preferably an alkyl group having 4 to 18 carbon atoms. Specific examples of the alkyl group include a methyl group, an ethyl group, a propyl group, an isopropyl group, a n-butyl group, a t-butyl group, an isobutyl group, an amyl group, an isoamyl group, a hexyl group, a heptyl group, a cyclohexyl group, a 2-ethylhexyl group, an octyl group, an isooctyl group, a nonyl group, an isononyl group, a decyl group, an isodecyl group, an undecyl group, a lauryl group, a tridecyl group, a tetradecyl group, a stearyl group, an octadecyl group, and a dodecyl group.

The monomer composition for forming the (meth)acrylic resin may contain any appropriate other monomer. Examples of the other monomer include functional group-containing monomers including: carboxyl group-containing monomers, such as acrylic acid, methacrylic acid, carboxyethyl acrylate, carboxypentyl acrylate, itaconic acid, maleic acid, fumaric acid, and crotonic acid; acid anhydride monomers, such as maleic anhydride and itaconic anhydride; hydroxyl group-containing monomers, such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)-methyl acrylate, 2-hydroxyethyl vinyl ether, 4-hydroxybutyl vinyl ether, and diethylene glycol monovinyl ether; sulfonic acid group-containing monomers, such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphoric acid group-containing monomers, such as 2-hydroxyethylacryloyl phosphate. The incorporation of the functional group-containing monomer can provide a (meth)acrylic resin into which a polymerizable carbon-carbon double bond is easily introduced. The content ratio of the functional group-containing monomer is preferably from 4 parts by weight to 30 parts by weight, more preferably from 6 parts by weight to 20 parts by weight with respect to 100 parts by weight of all the monomers of the monomer composition.

As the other monomer, a polyfunctional monomer may be used. When the polyfunctional monomer is used, for example, cohesive strength, heat resistance, or an adhesive property of the pressure-sensitive adhesive can be improved. In addition, the amount of the low-molecular-weight component in the pressure-sensitive adhesive layer is reduced, and hence the pressure-sensitive adhesive tape that hardly contaminates an adherend can be obtained. Examples of the polyfunctional monomer include hexanediol (meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy (meth)acrylate, polyester (meth)acrylate, and urethane (meth)acrylate. The content ratio of the polyfunctional monomer is preferably from 1 part by weight to 100 parts by weight, more preferably from 5 parts by weight to 50 parts by weight with respect to 100 parts by weight of all the monomers of the monomer composition.

The (meth)acrylic resin has a weight-average molecular weight of preferably 300,000 or more, more preferably 500,000 or more, still more preferably from 800,000 to 3,000,000. When the weight-average molecular weight falls within such ranges, bleeding of the low-molecular-weight component can be prevented, and hence the pressure-sensitive adhesive tape having a low contamination property can be obtained. The (meth)acrylic resin has a molecular weight distribution (weight-average molecular weight/number-average molecular weight) of preferably from 1 to 20, more preferably from 3 to 10. When the (meth)acrylic resin having a narrow molecular weight distribution is used, bleeding of the low-molecular-weight component can be prevented, and hence the pressure-sensitive adhesive tape having a low contamination property can be obtained. The weight-average molecular weight and the number-average molecular weight may be determined by gel permeation chromatography measurement (solvent: tetrahydrofuran, polystyrene equivalent).

The polymer having a polymerizable carbon-carbon double bond in a side chain or at a terminal thereof may be obtained by any appropriate method. The polymer may be obtained by, for example, subjecting a resin obtained by any appropriate polymerization method and a compound having a polymerizable carbon-carbon double bond to a reaction (e.g., condensation reaction or addition reaction). Specifically, when the (meth)acrylic resin is used, the polymer may be obtained by subjecting a (meth)acrylic resin (copolymer) having a structural unit derived from a monomer having any appropriate functional group to polymerization in any appropriate solvent, and then subjecting the resultant to a reaction between a functional group of the acrylic resin and the compound having a polymerizable carbon-carbon double bond that may react with the functional group. The amount of the compound having a polymerizable carbon-carbon double bond to be subjected to the reaction is preferably from 4 parts by weight to 30 parts by weight, more preferably from 4 parts by weight to 20 parts by weight with respect to 100 parts by weight of the above-mentioned resin. As the solvent, any appropriate solvent may be used. Examples thereof include various organic solvents, such as ethyl acetate, methyl ethyl ketone, and toluene.

When the resin and the compound having a polymerizable carbon-carbon double bond are subjected to a reaction with each other as described above, the resin and the compound having a polymerizable carbon-carbon double bond preferably have functional groups that can react with each other. The combination of the functional groups is, for example, a carboxyl group/an epoxy group, a carboxyl group/an aziridine group, or a hydroxyl group/an isocyanate group. Of those combinations of the functional groups, a combination of a hydroxyl group and an isocyanate group is preferred from the viewpoint of ease of reaction tracking.

Examples of the compound having a polymerizable carbon-carbon double bond include 2-isocyanatoethyl methacrylate, methacryloyl isocyanate, 2-methacryloyloxyethyl isocyanate (2-isocyanatoethyl methacrylate), and m-isopropenyl-α,α-dimethylbenzyl isocyanate.

When the pressure-sensitive adhesive obtained by adding the UV-curable monomer and/or oligomer is used, any appropriate monomer or oligomer may be used as each of the UV-curable monomer and oligomer. Examples of the UV-curable monomer include urethane (meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, and 1,4-butanediol di(meth)acrylate. Examples of the UV-curable oligomer include a urethane-based oligomer, a polyether-based oligomer, a polyester-based oligomer, a polycarbonate-based oligomer, and a polybutadiene-based oligomer. An oligomer having a molecular weight of from about 100 to about 30,000 is preferably used as the oligomer. The monomers and the oligomers may be used alone or in combination thereof.

The monomer and/or oligomer may be used in any appropriate amount in accordance with the kind of the pressure-sensitive adhesive to be used. The amount of the monomer and/or oligomer to be used is, for example, preferably from 5 parts by weight to 500 parts by weight, more preferably from 40 parts by weight to 150 parts by weight with respect to 100 parts by weight of the base polymer for forming the pressure-sensitive adhesive.

### C-2. Photopolymerization Initiator

Any appropriate initiator may be used as the photopolymerization initiator. Examples of the photopolymerization initiator include: acyl phosphine oxide-based photoinitiators, such as ethyl 2,4,6-trimethylbenzylphenyl phosphinate and (2,4,6-trimethylbenzoyl)-phenylphosphine oxide; α-ketol-based compounds, such as 4-(2-hydroxyethoxy)phenyl(2-hydroxy-2-propyl) ketone, α-hydroxy-α,α′-dimethylacetophenone, 2-methyl-2-hydroxypropiophenone, and 1-hydroxycyclohexyl phenyl ketone; acetophenone-based compounds, such as methoxyacetophenone, 2,2-dimethoxy-2-phenylacetophenone, 2,2-diethoxyacetophenone, and 2-methyl-1-[4-(methylthio)-phenyl]-2-morpholinopropane-1; benzoin ether-based compounds, such as benzoin ethyl ether, benzoin isopropyl ether, and anisoin methyl ether; ketal-based compounds, such as benzyl dimethyl ketal; aromatic sulfonyl chloride-based compounds, such as 2-naphthalenesulfonyl chloride; photoactive oxime-based compounds, such as 1-phenone-1,1-propanedione-2-(o-ethoxycarbonyl)oxime; benzophenone-based compounds, such as benzophenone, benzoylbenzoic acid, and 3,3′-dimethyl-4-methoxybenzophenone; thioxanthone-based compounds, such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; camphorquinone; halogenated ketones; and acyl phosphonates, and α-hydroxyacetophenones, such as 2-hydroxy-1-(4-(4-(2-hydroxy-2-methylpropionyl)benzyl)phenyl-2-methylpropane-1. Of those, 2,2-dimethoxy-2-phenylacetophenone and 2-hydroxy-1-(4-(4-(2-hydroxy-2-methylpropionyl)benzyl)phenyl-2-methylpropane-1 may be preferably used. The photopolymerization initiators may be used alone or in combination thereof.

As the photopolymerization initiator, a commercially available product may also be used. Examples thereof include products available under the product names of Omnirad 127 and Omnirad 651 from IGM Resins B.V.

The photopolymerization initiator may be used in any appropriate amount. The content of the photopolymerization initiator is preferably from 0.5 part by weight to 20 parts by weight, more preferably from 0.5 part by weight to 10 parts by weight with respect to 100 parts by weight of the above-mentioned UV-curable pressure-sensitive adhesive. When the content of the photopolymerization initiator is less than 0.5 part by weight, the UV-curable pressure-sensitive adhesive may not be sufficiently cured at the time of active energy ray irradiation. When the content of the photopolymerization initiator is more than 10 parts by weight, storage stability of the pressure-sensitive adhesive may reduce.

### C-3. Additive

The composition for forming a pressure-sensitive adhesive layer may contain any appropriate additive as required. Examples of the additive include a cross-linking agent, a catalyst (e.g., a platinum catalyst), a tackifier, a plasticizer, a pigment, a dye, a filler, an age resistor, a conductive material, a UV absorber, a light stabilizer, a peeling modifier, a softener, a surfactant, a flame retardant, and a solvent.

In at least one embodiment of the present invention, the active energy ray-curable pressure-sensitive adhesive further contains a cross-linking agent. Examples of the cross-linking agent include an isocyanate-based cross-linking agent, an epoxy-based cross-linking agent, an aziridine-based cross-linking agent, and a chelate-based cross-linking agent. The content ratio of the cross-linking agent is preferably from 0.01 part by weight to 10 parts by weight, more preferably from 0.02 part by weight to 5 part by weight, still more preferably from 0.025 part by weight to 0.5 part by weight with respect to 100 parts by weight of the base polymer in the active energy ray-curable pressure-sensitive adhesive. The flexibility of the pressure-sensitive adhesive layer can be controlled by the content ratio of the cross-linking agent. When the content of the cross-linking agent is less than 0.01 part by weight, the pressure-sensitive adhesive becomes sol, and hence the pressure-sensitive adhesive layer may not be formed. When the content of the cross-linking agent is more than 10 parts by weight, adhesiveness to an adherend may reduce, and the adherend may not be sufficiently protected.

In at least one embodiment of the present invention, the isocyanate-based cross-linking agent is preferably used. The isocyanate-based cross-linking agent is preferred because the cross-linking agent can react with various kinds of functional groups. A cross-linking agent having 3 or more isocyanate groups is particularly preferably used. When the isocyanate-based cross-linking agent is used as the cross-linking agent and the content ratio of the cross-linking agent falls within the above-mentioned ranges, the pressure-sensitive adhesive layer excellent in peelability even after heating and causing a remarkably reduced amount of an adhesive residue can be formed.

The thickness of the pressure-sensitive adhesive layer may be set to any appropriate value. The thickness of the pressure-sensitive adhesive layer is preferably from 1 μm to 10 μm, more preferably from 1 μm to 6 μm. When the thickness of the pressure-sensitive adhesive layer falls within the above-mentioned ranges, sufficient pressure-sensitive adhesive strength to an adherend can be exhibited.

The pressure-sensitive adhesive layer has a ratio between a silicon pressure-sensitive adhesive strength and a polyimide pressure-sensitive adhesive strength (silicon pressure-sensitive adhesive strength/polyimide pressure-sensitive adhesive strength) after UV irradiation of preferably 1.0 or less, more preferably 0.8 or less. When the ratio between the silicon pressure-sensitive adhesive strength and the polyimide pressure-sensitive adhesive strength falls within the above-mentioned ranges, an adhesive residue on an adherend at the time of peeling of the pressure-sensitive adhesive tape can be prevented. As used herein, the polyimide pressure-sensitive adhesive strength and the silicon pressure-sensitive adhesive strength after UV irradiation each refer to pressure-sensitive adhesive strength measured by the method described in examples below.

The pressure-sensitive adhesive layer has an elastic modulus before UV irradiation of preferably from 0.05 MPa to 2.0 MPa, more preferably from 0.075 MPa to 1.5 MPa, still more preferably from 0.3 MPa to 1.5 MPa, particularly preferably 0.4 MPa or more and less than 1.5 MPa. When the elastic modulus falls within such ranges, the pressure-sensitive adhesive tape having sufficient pressure-sensitive adhesive strength for holding an adherend can be obtained. As used herein, the elastic modulus of the pressure-sensitive adhesive layer refers to an elastic modulus (Young's modulus) measured by the following method.

The composition for forming a pressure-sensitive adhesive layer was applied to a separator so that the application thickness became 5 μm, and then dried at 130° C. for 2 minutes. Next, only the pressure-sensitive adhesive layer after application and drying was rolled from an end to produce a bar-like sample, and a thickness (sectional area) was measured. An initial gradient (Young's modulus) obtained by pulling the obtained sample with a tensile testing machine (manufactured by Shimadzu Corporation, product name: “AG-IS”) under the conditions of a chuck-to-chuck distance of 10 mm, a tensile rate of 50 mm/min, and room temperature was defined as an elastic modulus.

The elastic modulus of the pressure-sensitive adhesive layer after UV irradiation is preferably 1 MPa or more, more preferably 5 MPa or more, still more preferably 10 MPa or more. When the elastic modulus falls within such ranges, the pressure-sensitive adhesive tape excellent in peelability after a predetermined process (e.g., a backgrinding process) can be obtained. The elastic modulus of the pressure-sensitive adhesive layer after UV irradiation is, for example, 1,000 MPa or less, preferably 500 MPa or less, more preferably 400 MPa or less.

The pressure-sensitive adhesive layer may be formed of one layer, or two or more layers. When the pressure-sensitive adhesive layer is formed of two or more layers, the pressure-sensitive adhesive layer only needs to include at least one pressure-sensitive adhesive layer formed by using the composition for forming a pressure-sensitive adhesive layer containing the photopolymerization initiator. When the pressure-sensitive adhesive layer is formed of two or more layers, a pressure-sensitive adhesive layer formed by using the composition for forming a pressure-sensitive adhesive layer containing the photopolymerization initiator is preferably formed on a surface of the pressure-sensitive adhesive tape to be brought into contact with an adherend. A pressure-sensitive adhesive layer which is not formed of the composition for forming a pressure-sensitive adhesive layer may be formed of any appropriate pressure-sensitive adhesive composition. The pressure-sensitive adhesive composition may be a UV-curable pressure-sensitive adhesive or a pressure-sensitive adhesive.

### D. Intermediate Layer

The intermediate layer contains a photopolymerization initiator and is free from a UV-curable component. That is, the intermediate layer itself is not cured by UV irradiation even though the layer contains the photopolymerization initiator. Accordingly, the intermediate layer can maintain a desired flexibility before and after UV irradiation. In addition, when the intermediate layer contains the photopolymerization initiator, the photopolymerization initiator in the pressure-sensitive adhesive layer does not transfer to the intermediate layer. As a result, reduction of the content of the photopolymerization initiator in the pressure-sensitive adhesive layer with time can be suppressed. Accordingly, the pressure-sensitive adhesive tape can exhibit excellent light peelability after UV irradiation. As used herein, the UV-curable component refers to a component that may be cross-linked by UV irradiation and shrink by curing. The component is specifically, for example, the UV-curable monomer and oligomer, or the polymer having a polymerizable carbon-carbon double bond in a side chain or at a terminal thereof taken as an example in the above-mentioned section C.

The intermediate layer may be formed of any appropriate material. The intermediate layer may be formed of, for example, a resin, such as an acrylic resin, a polyethylene-based resin, an ethylene-vinyl alcohol copolymer, an ethylene vinyl acetate-based resin, or an ethylene methyl methacrylate resin, or a pressure-sensitive adhesive.

In at least one embodiment of the present invention, the intermediate layer is formed of a composition for forming an intermediate layer containing a (meth)acrylic polymer. The (meth)acrylic polymer preferably contains a constituent component derived from an alkyl (meth)acrylate. Examples of the alkyl (meth)acrylate include (meth)acrylic acid C1-C20 alkyl esters, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate.

The (meth)acrylic polymer may contain a constituent unit corresponding to the other monomer copolymerizable with the alkyl (meth)acrylate as required for the purpose of modifying, for example, cohesive strength, heat resistance, or cross-linkability. Examples of such monomer include: carboxyl group-containing monomers, such as acrylic acid and methacrylic acid; acid anhydride monomers, such as maleic anhydride and itaconic anhydride; hydroxyl group-containing monomers, such as hydroxyethyl (meth)acrylate and hydroxypropyl (meth)acrylate; sulfonic acid group-containing monomers, such as styrenesulfonic acid and allylsulfonic acid; nitrogen-containing monomers, such as (meth)acrylamide, N,N-dimethyl (meth)acrylamide, and acryloyl morpholine; aminoalkyl (meth)acrylate-based monomers, such as aminoethyl (meth)acrylate; alkoxyalkyl (meth)acrylate-based monomers, such as methoxyethyl (meth)acrylate; maleimide-based monomers, such as N-cyclohexyl maleimide and N-isopropyl maleimide; itaconimide-based monomers, such as N-methyl itaconimide and N-ethyl itaconimide; succinimide-based monomers; vinyl-based monomers, such as vinyl acetate, vinyl propionate, N-vinyl pyrrolidone, and methylvinyl pyrrolidone; cyano acrylate monomers, such as acrylonitrile and methacrylonitrile; epoxy group-containing acrylic monomers, such as glycidyl (meth)acrylate; glycol-based acrylic ester monomers, such as polyethylene glycol (meth)acrylate and polypropylene glycol (meth)acrylate; acrylic acid ester-based monomers each having a heterocycle, a halogen atom, or a silicon atom, such as tetrahydrofurfuryl (meth)acrylate, fluorine (meth)acrylate, and silicone (meth)acrylate; olefin-based monomers, such as isoprene, butadiene, and isobutylene; and vinyl ether-based monomers, such as vinyl ether. Those monomer components may be used alone or in combination thereof. The content ratio of the constituent unit derived from the other monomer is preferably from 1 part by weight to 30 parts by weight, more preferably from 3 parts by weight to 25 parts by weight in 100 parts by weight of the acrylic polymer.

The (meth)acrylic polymer has a weight-average molecular weight of preferably from 300,000 to 15,000,000, more preferably from 500,000 to 1,500,000. The weight-average molecular weight may be measured by GPC (solvent: THF).

The (meth)acrylic polymer has a glass transition temperature of preferably from −50° C. to 30° C., more preferably from −40° C. to 20° C. When the glass transition temperature falls within such ranges, the pressure-sensitive adhesive tape that is excellent in heat resistance and that can be suitably used in a heating step can be obtained.

The composition for forming an intermediate layer further includes the photopolymerization initiator. The photopolymerization initiator in the composition for forming an intermediate layer (the resulting intermediate layer) and the photopolymerization initiator in the pressure-sensitive adhesive layer may be identical to or different from each other. The intermediate layer and the pressure-sensitive adhesive layer preferably contain the same photopolymerization initiator. When the intermediate layer and the pressure-sensitive adhesive layer contain the same photopolymerization initiator, transfer of the photopolymerization initiator from the pressure-sensitive adhesive layer to the intermediate layer can be further suppressed. As the photopolymerization initiator, the photopolymerization initiator taken as an example in the above-mentioned section C may be used. The photopolymerization initiators may be used alone or in combination thereof.

The content of the photopolymerization initiator in the intermediate layer is preferably from 0.1 part by weight to 10 parts by weight, more preferably from 0.5 part by weight to 8 parts by weight with respect to 100 parts by weight of a polymer constituent component in the composition for forming an intermediate layer. When the content of the photopolymerization initiator in the intermediate layer falls within the above-mentioned ranges, the pressure-sensitive adhesive tape having excellent light peelability after UV irradiation can be obtained. In at least one embodiment of the present invention, the photopolymerization initiator is used in an equal amount to that in the composition for forming a pressure-sensitive adhesive layer.

In at least one embodiment of the present invention, the composition for forming an intermediate layer further contains a cross-linking agent. Examples of the cross-linking agent include an isocyanate-based cross-linking agent, an epoxy-based cross-linking agent, an oxazoline-based cross-linking agent, an aziridine-based cross-linking agent, a melamine-based cross-linking agent, a peroxide-based cross-linking agent, a urea-based cross-linking agent, a metal alkoxide-based cross-linking agent, a metal chelate-based cross-linking agent, a metal salt-based cross-linking agent, a carbodiimide-based cross-linking agent, and an amine-based cross-linking agent.

When the composition for forming an intermediate layer contains the cross-linking agent, the content ratio of the cross-linking agent is preferably from 0.5 part by weight to 10 parts by weight, more preferably from 1 part by weight to 8 parts by weight with respect to 100 parts by weight of the polymer constituent component in the composition for forming an intermediate layer.

The composition for forming an intermediate layer may further contain any appropriate additive as required. Examples of the additive include an active energy ray polymerization accelerator, a radical scavenger, a tackifier, a plasticizer (e.g., a trimellitic acid ester-based plasticizer or a pyromellitic acid ester-based plasticizer), a pigment, a dye, a filler, an age resistor, a conductive material, an antistatic agent, a UV absorber, a light stabilizer, a peeling modifier, a softener, a surfactant, a flame retardant, and an antioxidant.

The intermediate layer has a thickness of preferably from 20 μm to 300 μm, more preferably from 20 μm to 200 μm, still more preferably from 20 μm to 150 μm, particularly preferably from 20 μm to 100 μm. When the thickness of the intermediate layer falls within the above-mentioned ranges, the pressure-sensitive adhesive tape that can satisfactorily embed an uneven surface can be obtained.

The intermediate layer has an elastic modulus before UV irradiation of preferably from 0.01 MPa to 10.0 MPa, more preferably from 0.01 MPa to 5.0 MPa, still more preferably from 0.01 MPa to 1.0 MPa. When the elastic modulus falls within such ranges, the pressure-sensitive adhesive tape that can satisfactorily embed unevenness of an adherend surface can be obtained. In addition, adherend holding strength of the pressure-sensitive adhesive tape can be improved.

### E. Production Method for Pressure-Sensitive Adhesive Tape

The pressure-sensitive adhesive tape may be produced by any appropriate method. The pressure-sensitive adhesive tape may be produced by, for example, forming the intermediate layer on the base material, and then forming the pressure-sensitive adhesive layer on the intermediate layer. The pressure-sensitive adhesive layer and the intermediate layer may be formed by applying the composition for forming a pressure-sensitive adhesive layer and the composition for forming an intermediate layer onto the base material and the intermediate layer, respectively, or may each be formed by forming the layer on any appropriate separator and then transferring the layer. Various methods, such as bar coater coating, air knife coating, gravure coating, gravure reverse coating, reverse roll coating, lip coating, die coating, dip coating, offset printing, flexographic printing, and screen printing, can each be adopted as a method for the application. In addition, for example, a method involving separately forming the pressure-sensitive adhesive layer on a separator and then bonding the resultant to the base material may be adopted.

### F. Usage of Pressure-Sensitive Adhesive Tape

The pressure-sensitive adhesive tape of the present invention can be used in any appropriate usage. As described above, the pressure-sensitive adhesive tape of the present invention has excellent pressure-sensitive adhesive strength to an adherend before UV irradiation and excellent peelability after UV irradiation. Accordingly, the pressure-sensitive adhesive tape can be suitably used in a usage where excellent pressure-sensitive adhesive strength and excellent peel strength are needed.

In at least one embodiment of the present invention, the pressure-sensitive adhesive tape can be suitably used in a processing step of a semiconductor wafer. The pressure-sensitive adhesive tape has excellent pressure-sensitive adhesive strength to an adherend before UV irradiation and excellent peelability after UV irradiation. Accordingly, at the time of processing of a thin wafer, breakage of the wafer can be avoided, and peeling can be performed with lower strength. In addition, the pressure-sensitive adhesive tape includes the intermediate layer, and hence, even when applied to an adherend having unevenness, the pressure-sensitive adhesive tape can satisfactorily follow the unevenness. Accordingly, the adherend can be held at the time of the processing, and peeling from the adherend can be performed without a failure, such as an adhesive residue, after the processing.

In at least one embodiment of the present invention, the pressure-sensitive adhesive tape can be suitably used as a backgrind tape. The pressure-sensitive adhesive tape can exhibit excellent light peelability after UV irradiation. In addition, excellent light peelability can be exhibited after UV irradiation irrespective of the structure of the adherend surface. Therefore, an adhesive residue on the adherend surface can be prevented even when the adherend surface has a complex structure. Accordingly, the pressure-sensitive adhesive tape can be easily peeled from the adherend after a backgrinding process, and an adhesive residue on the adherend can also be prevented.

### EXAMPLES

Now, the present invention is specifically described by way of examples, but the present invention is not limited to these examples. Test and evaluation methods in the examples are as described below. In addition, “part(s)” and “%” are by weight unless otherwise stated.

### <Production Example 1> Preparation of Polymer for Composition for Forming Intermediate Layer

A monomer composition (solid content concentration: 25%) was prepared by using, as main monomers, 50 parts by weight of butyl acrylate and 50 parts by weight of ethyl acrylate, and, as functional group-containing monomers, 5 parts by weight of a 80% acrylic acid 20% toluene solution, 0.1 part by weight of 2-hydroxyethyl acrylate (manufactured by Toagosei Co., Ltd., product name: ACRYCS (trademark) HEA), and 0.3 part by weight of trimethylolpropane triacrylate (manufactured by Osaka Organic Chemical Industry Ltd., product name: Viscoat #295), followed by mixing those monomers, 0.1 part by weight of a polymerization initiator (manufactured by NOF Corporation, product name: NYPER (trademark) BW), and a solvent (toluene). The monomer composition was loaded into an experimental apparatus for polymerization with a 1-liter round-bottom separable flask with a separable cover, a separating funnel, a temperature gauge, a nitrogen-introducing tube, a Liebig condenser, a vacuum seal, a stirring rod, and a stirring blade, and while the composition was stirred, the inside of the apparatus was purged with nitrogen at normal temperature for 6 hours. After that, while the composition was stirred in a stream of nitrogen, the composition was held at 60° C. for 8 hours to be polymerized. Thus, a resin solution (polymer solution for a composition for forming an intermediate layer) was obtained.

### <Production Example 2> Preparation of Prepolymer

A monomer composition (solid content concentration: 32%) was prepared by mixing 100 parts by weight of 2-ethylhexyl acrylate, 25.5 parts by weight of acryloylmorpholine acid, 18.5 parts by weight of 2-hydroxylethyl acrylate (manufactured by Toagosei Co., Ltd., product name: ACRYCS (trademark) HEA), 0.275 part by weight of a polymerization initiator (manufactured by NOF Corporation, product name: NYPER (trademark) BW), and a solvent (toluene). The monomer composition was loaded into an experimental apparatus for polymerization with a 1-liter round-bottom separable flask with a separable cover, a separating funnel, a temperature gauge, a nitrogen-introducing tube, a Liebig condenser, a vacuum seal, a stirring rod, and a stirring blade, and while the composition was stirred, the inside of the apparatus was purged with nitrogen at normal temperature for 6 hours. After that, while the composition was stirred in a stream of nitrogen, the composition was held at 60° C. for 8 hours to be polymerized. Thus, a resin solution was obtained.

### <Production Example 3> Preparation of Polymer 1 for Forming Pressure-Sensitive Adhesive Layer

As the compound having a polymerizable carbon-carbon double bond, 12.3 parts by weight of 2-isocyanatoethyl methacrylate (manufactured by Showa Denko K.K., product name: “Karenz MOI”) was added to 144.262 parts by weight of a solid content of the resin solution obtained in Production Example 2. Further, 0.0633 part by weight of dibutyltin(IV) dilaurate (manufactured by Wako Pure Chemical Corporation) was added and a solvent (toluene) was appropriately added to adjust the solid content concentration to 34%. After that, under an air atmosphere, the resultant was stirred at 50° C. for 24 hours. Thus, a polymer solution (polymer 1 for forming a pressure-sensitive adhesive layer) was obtained.

### <Production Example 4> Preparation of Polymer 2 for Forming Pressure-Sensitive Adhesive Layer

As the compound having a polymerizable carbon-carbon double bond, 22.5 parts by weight of 2-isocyanatoethyl methacrylate (manufactured by Showa Denko K.K., product name: “Karenz MOI”) was added to 144.275 parts by weight of a solid content of the resin solution obtained in Production Example 2. Further, 0.0633 part by weight of dibutyltin(IV) dilaurate (manufactured by Wako Pure Chemical Corporation) was added and a solvent (toluene) was appropriately added to adjust the solid content concentration to 34%. After that, under an air atmosphere, the resultant was stirred at 50° C. for 24 hours. Thus, a polymer solution (polymer 2 for forming a pressure-sensitive adhesive layer) was obtained.

### Example 1

A composition (solid content concentration: 23 wt %) for forming an intermediate layer containing 100 parts by weight of the polymer for a composition for forming an intermediate layer obtained in Production Example 1, 1 part by weight of a polyisocyanate compound (product name: “Coronate L”, manufactured by Tosoh Corporation), 3 parts by weight of a photopolymerization initiator (manufactured by IGM Resins B.V., product name: Omnirad 651), and ethyl acetate was prepared. Next, the composition for forming an intermediate layer thus obtained was applied to a silicone treatment surface of a polyester-based separator having a thickness of 38 μm (product name: “MRF”, manufactured by Mitsubishi Plastics, Inc.), and then the solvent was removed by heating at 120° C. for 120 seconds. Thus, an intermediate layer having a thickness of 150 μm was formed.

Next, the intermediate layer formed on the separator was bonded to an antistatic treatment surface of an antistatic PET film having a thickness of 50 μm.

A composition for forming a pressure-sensitive adhesive layer (solid content: 15 wt %) was prepared in the same manner as the composition for forming an intermediate layer except that the polymer 1 for forming a pressure-sensitive adhesive layer was used instead of the polymer for a composition for forming an intermediate layer and the addition amount of the photopolymerization initiator was changed to 5 parts by weight. The composition for forming a pressure-sensitive adhesive layer thus obtained was applied to a silicone treatment surface of a polyester-based separator having a thickness of 75 μm, and then the solvent was removed by heating at 120° C. for 120 seconds. Thus, a pressure-sensitive adhesive layer having a thickness of 6 μm was formed.

Next, the separator was peeled from the intermediate layer, the pressure-sensitive adhesive layer was bonded to the intermediate layer to transfer the pressure-sensitive adhesive layer, and the resultant was kept at 50° C. for 72 hours. Thus, a pressure-sensitive adhesive tape including the base material, the intermediate layer, and the pressure-sensitive adhesive layer in the stated order was obtained.

### Example 2

A pressure-sensitive adhesive tape was obtained in the same manner as in Example 1 except that a PET film having a thickness of 100 μm subjected to antistatic treatment was used as the base material, and the thickness of the intermediate layer and the thickness of the pressure-sensitive adhesive layer were changed to 100 μm and 5 μm, respectively.

### Example 3

A pressure-sensitive adhesive tape was obtained in the same manner as in Example 1 except that the thickness of the pressure-sensitive adhesive layer was changed to 5 μm.

### Example 4

A pressure-sensitive adhesive tape was obtained in the same manner as in Example 3 except that 0.5 part by weight of an epoxy-based cross-linking agent (manufactured by Mitsubishi Gas Chemical Company, Inc., product name: “TETRAD-C”) was further added to the composition for forming an intermediate layer.

### Example 5

A pressure-sensitive adhesive tape was obtained in the same manner as in Example 3 except that the thickness of the intermediate layer was changed to 100 μm.

### Example 6

A composition for forming an intermediate layer was obtained in the same manner as in Example 1 except that a product available under the product name of Omnirad 127D from IGM Resins B.V. was used as the photopolymerization initiator. An intermediate layer was formed on the separator in the same manner as in Example 1 except that the composition for forming an intermediate layer thus obtained was used.

In addition, a composition for forming a pressure-sensitive adhesive layer was obtained in the same manner as in Example 1 except that the polymer 2 for forming a pressure-sensitive adhesive layer was used instead of the polymer 1 for forming a pressure-sensitive adhesive layer, and the product available under the product name of Omnirad 127D from IGM Resins B.V. was used as the photopolymerization initiator.

A pressure-sensitive adhesive tape was obtained in the same manner as in Example 3 except that the intermediate layer and the composition for forming a pressure-sensitive adhesive layer were used.

### Example 7

A pressure-sensitive adhesive tape was obtained in the same manner as in Example 6 except that a PET film having a thickness of 50 μm (manufactured by Toray Industries, Inc., product name: Lumirror S105) not having been subjected to antistatic treatment was used as the base material.

### Comparative Example 1

A pressure-sensitive adhesive tape was obtained in the same manner as in Example 6 except that the photopolymerization initiator was not added to the composition for forming an intermediate layer.

The following evaluations were performed using the pressure-sensitive adhesive tapes obtained in the examples and the comparative example. The results are shown in Table 1.

### (1) Pressure-Sensitive Adhesive Strength

The silicon pressure-sensitive adhesive strength (Si pressure-sensitive adhesive strength) and the polyimide pressure-sensitive adhesive strength (PI pressure-sensitive adhesive strength) were measured by using a Si mirror wafer (manufactured by Shin-Etsu Chemical Co., Ltd.) and a wafer coated with non-photosensitive polyimide (manufactured by KST World) as adherends. The pressure-sensitive adhesive tape cut in 20 mm width with a cutter was used. The tape was bonded to the wafer by reciprocating a 2-kilogram roller once. The measurement was performed with a tensile testing machine (TENSILON) (manufactured by MinebeaMitsumi Inc., product name: TG-1kN) in conformity with JIS Z 0237 (2000). Specifically, the tape was peeled at a tensile rate of 300 mm/min, room temperature, and a peeling angle of 180°. The strength after UV irradiation was measured as follows: the pressure-sensitive adhesive tape was bonded to the wafer, and was stored at normal temperature for 30 minutes, followed by UV irradiation (1,000 mJ/cm²) with a high-pressure mercury lamp (70 mW/cm², manufactured by Nitto Seiki Co., Ltd., product name: UM-810) for about 12 seconds, and then the measurement was performed.

In addition, a pressure-sensitive adhesive strength ratio to the Si mirror wafer (to Si) and a pressure-sensitive adhesive strength ratio to polyimide (to PI) were calculated from the following formula.

Pressure-sensitive adhesive strength ratio=(pressure-sensitive adhesive strength before UV irradiation−pressure-sensitive adhesive strength after UV irradiation)/pressure-sensitive adhesive strength before UV irradiation×100

### (2) Elastic Modulus

The composition for forming an intermediate layer used in each of the examples and the comparative example was applied to the separator to have an application thickness of 5 and was dried at 130° C. for 2 minutes. Next, only the intermediate layer after the application and drying was rolled from an end to produce a bar-like sample, and the thickness (sectional area) was measured. An initial gradient (Young's modulus) obtained by pulling the obtained sample with a tensile testing machine (manufactured by Shimadzu Corporation, product name: “AG-IS”) under the conditions of a chuck-to-chuck distance of 10 mm, a tensile rate of 50 mm/min, and room temperature was defined as an elastic modulus. The intermediate layer was subjected to UV irradiation (1,000 mJ/cm²) with a high-pressure mercury lamp (70 mW/cm², manufactured by Nitto Seiki Co., Ltd., product name: UM-810). Thus, the elastic modulus before and after the irradiation was measured.

### (3) Peelability

The pressure-sensitive adhesive tape obtained in each of the examples and the comparative example was bonded to an 8-inch Si mirror wafer (thickness: 750 μm) with an application apparatus (manufactured by Nitto Seiki Co., Ltd., product name: DR-3000III) under the conditions of an application rate of 5 mm/second and an application pressure of 0.5 MPa. Next, the Si mirror wafer was ground with a backgrinding apparatus (manufactured by DISCO Corporation, product name: DFG8560) to have finish thicknesses of 50 μm, 100 μm, and 250 μm. Next, the ground Si mirror wafer was mounted to a dicing tape (manufactured by Nitto Denko Corporation, product name: DU-2187G) with a mounting apparatus (manufactured by Nitto Seiki Co., Ltd., product name: MSA-840). After the pressure-sensitive adhesive tape was subjected to UV irradiation (700 mJ/cm²), a peeling tape (manufactured by Nitto Denko Corporation, product name: BT-315) was bonded to the pressure-sensitive adhesive tape, and the pressure-sensitive adhesive tape was then peeled with a peeling apparatus (manufactured by Nitto Seiki Co., Ltd., product name: RM300-NV4) under the conditions of a table temperature of 20° C., a bar temperature of 30° C., a peel start of −1 mm, and a peeling rate of 10 mm/second. The state of the Si mirror wafer after peeling was visually observed. Thus, the peelability was evaluated.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Thickness of base material (μm) | | 50 | 100 | 50 | 50 | 50 | 50 | 50 | 50 |
| Presence or absence of antistatic layer | | Present | Present | Present | Present | Present | Present | Absent | Present |
| Thickness of pressure-sensitive adhesive layer | | 6 | 5 | 5 | 5 | 5 | 5 | 5 | 5 |
| Presence or absence of intermediate layer initiator | | Present | Present | Present | Present | Present | Present | Present | Absent |
| Pressure-sensitive | Si | 15 | 25 | 26 | 11 | 19 | 21 | 21 | 22 |
| adhesive strength before | PI | 15 | 23 | 21 | 10 | 17 | 23 | 23 | 23 |
| UV irradiation | | | | | | | | | |
| (N/20 mm) | | | | | | | | | |
| Pressure-sensitive | Si | 0.2 | 0.03 | 0.08 | 0.07 | 0.07 | 0.07 | 0.07 | 0.11 |
| adhesive strength after | PI | 0.2 | 0.13 | 0.12 | 0.12 | 0.13 | 0.09 | 0.09 | 23 |
| UV irradiation | Si/PI ratio | 1.00 | 0.23 | 0.67 | 0.58 | 0.54 | 0.78 | 0.78 | 0.004 |
| (N/20 mm) | | | | | | | | | |
| To Si | | 98.6 | 99.9 | 99.7 | 99.4 | 99.6 | 99.7 | 99.7 | 99.5 |
| To Pl | | 98.6 | 99.4 | 99.4 | 98.8 | 99.2 | 99.6 | 99.6 | −1.3 |
| Elastic modulus of | Before UV irradiation | 0.16 | 0.16 | 0.16 | 0.44 | 0.16 | 0.16 | 0.16 | 0.16 |
| intermediate layer | After UV irradiation | 0.16 | 0.16 | 0.16 | 0.44 | 0.16 | 0.16 | 0.16 | 0.16 |
| (MPa) | Before UV irradiation/ | 1.0 | 1.0 | 1.0 | 1.0 | 1.0 | 1.0 | 1.0 | 1.0 |
| | after UV irradiation | | | | | | | | |
| Peelability | 50 μm | Satis- | Satis- | Satis- | Satis- | Satis- | Satis- | Satis- | Crack |
| | | factory | factory | factory | factory | factory | factory | factory | |
| | 100 μm | Satis- | Satis- | Satis- | Satis- | Satis- | Satis- | Satis- | Crack |
| | | factory | factory | factory | factory | factory | factory | factory | |
| | 200 μm | Satis- | Satis- | Satis- | Satis- | Satis- | Satis- | Satis- | Satis- |
| | | factory | factory | factory | factory | factory | factory | factory | factory |

The pressure-sensitive adhesive tape of the present invention can be used in any appropriate usage. Specifically, the pressure-sensitive adhesive tape can be suitably used in, for example, a semiconductor wafer processing step.

The pressure-sensitive adhesive tape of the present invention includes: the pressure-sensitive adhesive layer containing the UV-curable pressure-sensitive adhesive and the photopolymerization initiator; the intermediate layer containing the photopolymerization initiator and being free from the UV-curable component; and the base material. That is, the intermediate layer itself is not cured by UV irradiation even though the layer contains the photopolymerization initiator. The intermediate layer that is not cured by UV irradiation also contains the photopolymerization initiator as well as the pressure-sensitive adhesive layer that is cured by UV irradiation. Thus, the pressure-sensitive adhesive tape that can exhibit excellent light peelability after UV irradiation can be obtained.

What is claimed is:

1. A pressure-sensitive adhesive tape, comprising:
a pressure-sensitive adhesive layer containing an ultraviolet (UV)-curable pressure-sensitive adhesive and a photopolymerization initiator;
an intermediate layer containing the photopolymerization initiator and being free from a UV-curable component; and
a base material.

2. The pressure-sensitive adhesive tape according to claim 1, wherein a content of the photopolymerization initiator in a composition for forming the intermediate layer is from 0.1 part by weight to 10 parts by weight.

3. The pressure-sensitive adhesive tape according to claim 1, wherein the pressure-sensitive adhesive layer and the intermediate layer each contain the photopolymerization initiator in an equal amount.

4. The pressure-sensitive adhesive tape according to claim 1, wherein the base material has an antistatic function.

5. The pressure-sensitive adhesive tape according to claim 1, wherein the pressure-sensitive adhesive layer after UV irradiation has a ratio between a silicon pressure-sensitive adhesive strength and a polyimide pressure-sensitive adhesive strength of 1.0 or less.

6. The pressure-sensitive adhesive tape according to claim 1, wherein the pressure-sensitive adhesive layer has a thickness of from 1 μm to 10 μm.

7. The pressure-sensitive adhesive tape according to claim 1, wherein the base material has a thickness of from 10 μm to 200 μm.

8. The pressure-sensitive adhesive tape according to claim 1, wherein the pressure-sensitive adhesive tape is used in a semiconductor wafer processing step.

9. The pressure-sensitive adhesive tape according to claim 8, wherein the pressure-sensitive adhesive tape is used as a backgrind tape.

10. The pressure-sensitive adhesive tape according to claim 8, wherein the pressure-sensitive adhesive tape is used by being bonded to an adherend having unevenness.
